(19) United States
(12) Patent Application Publication
(10) Pub. No.: US 2025/0381657 A1
(43) Pub. Date: Dec. 18, 2025

(54) TOOL AND HOUSING PART FOR A PORTABLE TOOL

(71) Applicant: ANDREAS STIHL AG & Co. KG, Waiblingen (DE)

(72) Inventors: Jens MÜLLER, Ludwigsburg (DE); Stefan RICHTER, Remseck (DE); Marcel WITT, Alfdorf (DE); Marco SCHMID, Korntal-Münchingen (DE); Oliver SCHMIDT, Waiblingen (DE); Tobias WAGNER, Berglen (DE); Alexander SCHEEL, Schwäbisch Gmünd (DE)

(73) Assignee: ANDREAS STIHL AG & Co. KG, Waiblingen (DE)

(21) Appl. No.: 19/236,403

(22) Filed: Jun. 12, 2025

(30) Foreign Application Priority Data
Jun. 14, 2024 (DE) 10 2024 116 785.8

(51) Int. Cl. B25F 5/02; B25F 5/00

(52) U.S. Cl. CPC B25F 5/02; B25F 5/006

(57) ABSTRACT

A housing part for a portable tool, in particular for a portable motor-driven electric tool, and/or for a power supply device of a portable electric tool, has a functional structure for absorbing an impact energy during a collision process. The functional structure has a contact section that is arranged and configured to directly absorb the impact energy and to carry out a deformation. The functional structure has a deformation zone that is arranged at the contact section and configured to receive a deformation of the contact section. The functional structure has a stop section that is arranged and configured to limit the deformation of the contact section and to transfer at least a part of the impact energy. A portable motor-driven electric tool can include at least one such housing part.

### CROSS-REFERENCE TO RELATED APPLICATIONS

This application claims priority under 35 U.S.C. § 119 to German patent application De 102024116785.8, filed Jun. 14, 2024, the entire disclosure of which is incorporated herein by reference.

### BACKGROUND OF THE DISCLOSURE

### 1. Field of the Disclosure

The present disclosure is in the field of structural mechanics for tools, in particular for portable and/or hand-held tools, for optimizing impact and/or collision behaviour. The present disclosure relates to a housing part for a portable tool and/or for a power supply device of a portable electric tool. Furthermore, the present disclosure relates to a protective element for a portable tool. In addition, the present disclosure relates to a tool, in particular a portable motor-driven tool, with at least one housing part and/or with a protective element.

### 2. Description of Related Art

Tools, in particular portable and/or hand-held tools, are used in different areas and environments depending on their purpose and must therefore fulfil different requirements and properties.

For example, one requirement for tools in the form of portable motor-driven power tools is to ensure sufficient stability and/or strength in the event of an impact or collision in order to prevent damage or destruction. During manual operation, electric tools are exposed to a collision or impact, particularly through careless handling such as accidental dropping.

To protect tool units and/or devices inside the tool from damage or destruction, the housing of the tool is always used first, although external attachment parts such as protective bars can also be used. This is particularly relevant, for example, for chainsaws, especially battery-driven pruning saws, hedge trimmers or cut-off grinders, as comparatively high drop heights can occur here, which in turn result in high impact energies during a collision process.

One challenge, especially in connection with portable electric tools such as chainsaws, cut-off grinders, hedge trimmers, motorized scythes, brush cutters, blowers, etc., is the compromise between a relatively low weight for good handling on the one hand and sufficient stiffness to protect internal tool units from mechanical loads and ensure functionality on the other.

### SUMMARY OF THE DISCLOSURE

It is an object of the present disclosure to provide a housing part for a portable tool and/or for a power supply device of a portable electric tool, which is characterized by improved energy absorption properties, in particular during a collision process. Furthermore, it is an object of the present disclosure to provide a tool and/or a power supply device with at least one such housing part.

A further task of the present disclosure is to provide a protective element for a portable tool, which is characterized by improved energy absorption properties, in particular during a collision process, in order to protect, in particular, firstly the housing of the tool and furthermore tool units and/or devices inside the housing. Furthermore, it is an object of the present disclosure to provide a tool with such a protective element.

According to a general aspect, the present disclosure relates to a housing part for a portable tool, in particular for a portable motor-driven electric tool, and/or for a power supply device of a portable electric tool, having a functional structure for absorbing an impact energy during a collision process, wherein the functional structure comprises a contact section which is arranged and configured to directly (immediately) absorbing the impact energy and to carry out a deformation, wherein the functional structure comprises a deformation zone which is arranged at the contact section and configured to receive a deformation of the contact section, and wherein the functional structure comprises a stop section which is arranged and configured to limit the deformation of the contact section, in particular to limit it in a defined direction, and to transfer at least a part of the impact energy.

With the present disclosure, a housing part with a functional structure is provided, which is characterized in particular by an improved energy absorption behaviour during a collision process, namely during the collision process in both spatial and temporal terms. The collision process can result from an impact of the housing part or the tool equipped with the housing part on a floor and/or from a collision with another body. The form of the functional structure makes it possible, for example, to reduce impact energy in the form of shock energy in a collision direction by deformation in at least one defined direction relative to the collision direction and/or during a defined period of time.

In particular, the contact section forms an active section of the functional structure, which moves during a collision process. The stop section is in particular a passive section of the functional structure, which does not move in relation to the contact section and/or to the housing part as a whole during a collision process and/or essentially does not change its original shape.

Due to the inherent property for the direct (immediate) absorption of impact energy, the housing part is in particular an outer housing part for the portable tool. The housing part can, for example, be formed to receive and/or guide at least one section of a replaceable energy supply device and/or another tool unit of a tool. In relation to the tool, the energy supply device can be formed as a rechargeable accumulator that can be changed manually and/or tool-free. In other words, the tool can be formed for operation with a manually and/or tool-free changeable, rechargeable accumulator.

The portable tool can, for example, be a portable motor-driven electric tool in the form of a chainsaw, in particular a pruning saw, a cut-off grinder, a brush cutter, a blower or a hedge trimmer. Of course, the portable tool can also be configured and/or formed for other purposes. The tool can be configured for use in the garden, in the household, in leisure, in forestry, in industry and/or in agriculture.

The arrangement of the deformation zone on the contact section represents in particular an area directly (immediately) adjacent to the contact section, which is available for deformation of the contact section. The defined direction for limiting the deformation of the contact section can, for example, be a direction that is essentially parallel to a resulting or idealized collision direction. Additionally or alternatively, the defined direction of deformation can be at least one direction that is oblique to the collision direction.

According to a further aspect of the present disclosure, it can be provided that the stop section, in particular up to a defined energy limit value for the impact energy, is formed to be substantially dimensionally stable in order to distribute the at least part of the impact energy; and/or that the contact section, in particular up to a defined energy limit value for the impact energy, is formed to be partially variable in shape and configured to carry out the deformation essentially reversibly.

In other words, the stop section can be formed to be essentially deformation-resistant and characterized by a corresponding material strength and/or structural strength so that it is essentially not subject to deformation, in particular up to the defined energy limit value. As a result, tool units and/or devices of the tool adjacent to the stop section can be effectively protected against damage or destruction in the event of a collision process. The stop section can be formed sufficiently stiff and/or rigid.

The contact section can be formed partially variable in shape, so that up to a defined energy limit value for the impact energy, at least part of the contact section is essentially reversibly deformed and thus essentially returns to its original shape after the collision process. The energy limit value for the impact energy can, for example, be defined by a drop height of a tool with an integrated or received energy supply device for which the housing part is provided. For example, the energy limit can be defined on the basis of a 5 kg electric tool with a design drop height of 5 m and be approximately 247 joules.

It is possible that the deformation zone is arranged between the contact section and the stop section so that a distance is formed between the contact section and the stop section, wherein the distance is essentially constant along an extension of the deformation zone in a circumferential direction, or varies and in particular assumes a defined maximum value.

In other words, the contact section, the deformation zone and the stop section can be formed sandwiched in sections. The functional structure can thus be characterized by a double-wall arrangement.

The circumferential direction can characterize at least one direction and/or a change in direction of the housing part, in which the housing part and thus the functional structure extends, in particular on an outer side. Due to the essentially constant or varying distance between the contact section and the stop section, a deformation behaviour of the contact section and thus a defined energy absorption behaviour of the functional structure can be realized. Furthermore, the distance, especially if it assumes a defined maximum value, can be used to define and/or realize, for example, a maximum deformation path for at least part of the contact section. The distance and/or the change in the distance along the contact section and/or the stop section can characterize the formation of the deformation zone.

According to a further aspect of the present disclosure, it can be provided that the contact section comprises at least one predetermined breaking point, which is configured to cause a defined breakage of the contact section when a defined energy limit value for the impact energy is reached and/or exceeded.

The predetermined breaking point can be a location on the contact section that is damaged or destroyed during the collision process in order to absorb at least part of the impact energy and, in particular, to keep the stop section or the (remaining) residual structure of the housing part outside the functional structure free of damage or destruction. The predetermined breaking point can be a localized point on the contact section, which is characterized, for example, by a smaller thickness of the contact section in comparison or by a notch in the contact section. The defined energy limit value can, for example, be determined by a drop test with a defined drop direction and thus a defined collision direction and/or with a defined drop height and/or with a defined location of the tool. The defined fracture can be a forced fracture.

It is possible that the contact section, the deformation zone and/or the stop section are each formed curved in a common direction; and/or that in a front view the deformation zone is characterized by an arc-segment shaped outline with rounded transitions between the contact section and the stop section.

This allows, for example, an increase in the stiffness of the functional structure to be realized, while at the same time maintaining the energy absorption properties of the functional structure. Rounded transitions can, for example, prevent a concentration of mechanical loads, for example in the form of stresses, in the functional structure during a collision process and at least part of the impact energy can be optimally distributed and/or transferred at other points.

According to a further aspect of the present disclosure, it can be provided that the deformation zone is formed as a cavity, or that the deformation zone is at least partially filled with a filling material, wherein the filling material is configured to dampen and/or delay the deformation of the contact section.

By equipping a part of the deformation zone with the filling material, the deformation zone, i.e. the filling material, can actively participate in and influence the deformation of the contact section during a collision process. The filling material can be a foam, for example based on polyurethane.

The filling material makes it possible to extend the time period of the deformation of the contact section, i.e. to delay it in order to gradually reduce the impact energy.

The cavity can be formed closed or half-open in at least one direction.

It is possible that a thickness of the contact section is essentially constant along an extension of the contact section in a circumferential direction. In this case, the contact section can be formed as a simple wall section with an essentially constant thickness.

Alternatively, it is possible that a thickness of the contact section varies along an extension of the contact section in a circumferential direction and, in particular, decreases from a defined maximum value to a defined minimum value, for example, decreases steadily and, in particular, then increases to the defined maximum value, for example, increases steadily.

The contact section can be a wall or a wall section of the functional structure, which is characterized by a varying thickness, wherein in the circumferential direction, in particular the thickness changes from a defined maximum value to a defined minimum value, in order in particular to subsequently increase again to the defined maximum value. In other words, the thickness can represent a varying wall thickness of the contact section, wherein the contact section narrows along its extension in a circumferential direction to a minimum wall thickness, then remains essentially constant in some cases and then widens again.

This allows, for example, a defined and thus a targeted or intended deformation behaviour of the contact section to be realized during a collision process, wherein the area of the contact section with the defined minimum thickness value dominates the deformation of the contact section. The area of the contact section with the defined minimum thickness value of the thickness can be surrounded by the other areas of the contact section in at least two directions.

According to a further aspect of the present disclosure, it can be provided that the contact section and the stop section each have a different stiffness, wherein in particular the stiffness of the stop section is greater than the stiffness of the contact section.

A resulting and/or idealized stiffness of the stop section can, for example, be at least twice as great as a resulting and/or idealized stiffness of the contact section.

This ensures in particular that during a collision process, the absorption of impact energy is essentially realized by the contact section in conjunction with the deformation zone and the stop section forms a sufficient limit for the deformation of the contact section.

It is possible for the stiffness of the contact section to be greater along an extension of the contact section in a circumferential direction than in at least one direction perpendicular to it. This can be achieved, for example, by using materials based on fibre-reinforced plastics, with which stiffness properties can be specifically influenced in the respective directions.

It is possible that the functional structure comprises a reinforcing element which is configured to increase a stiffness of the stop section and to at least partially receive and/or substantially neutralize a torsional load occurring during the collision process, wherein the reinforcing element is arranged on the stop section on a side opposite the deformation zone, and/or wherein the reinforcing element is formed hollow shaft-shaped or tubular in sections and extends substantially perpendicular to a circumferential direction and/or to a deformation direction of the contact section.

The reinforcing element, which is formed directly (immediately) on the stop section or merges into it, can be characterized in a front view or at least in a sectional view by an essentially circular cross-section. The reinforcing element can be connected to other reinforcing elements of the housing part, for example in the form of ribs, struts, grooves and/or beads.

According to a further aspect of the present disclosure, it can be provided that the housing part is integrally formed in one piece with the functional structure as a single part, in particular by at least one injection process, at least one casting process and/or by at least one laminating process; and that the functional structure is formed to be half-open and/or free of undercuts in a direction substantially perpendicular to a circumferential direction, and/or that the contact section and/or the stop section is formed in band-shaped and/or rib-shaped and each extends along a circumferential direction.

In other words, the functional structure can be an integral part of the housing part and thus represent an integrated impact structure or collision structure of the housing part.

The housing part can additionally or alternatively be formed by at least one 3D printing process or by at least one sintering process. The housing part can essentially be formed from a material based on a plastic. The plastic can be an injectable, a moldable and/or a curable plastic. The stop section can be formed at least partially from a fiber-reinforced plastic.

According to a further aspect of the present disclosure, it can be provided that at least one of the following elements is arranged and/or formed on the stop section for supporting at least one tool unit and/or a device, in particular a power supply device, of the tool in an assembly state: a rib, a strut, a groove, a bead, a projection, and/or at least one half-open chamber with, for example, a triangular or rectangular outline.

This can, for example, increase stiffness at defined points on the housing part in order to further improve the protection of tool units and/or devices by the housing part, particularly in the event of mechanical loads occurring during a collision process.

According to a further general aspect, the present disclosure relates to a tool, in particular a portable motor-driven electric tool, with at least one housing part as disclosed herein, wherein the at least one housing part is arranged and formed to support a power supply device, in particular a power supply device which can be changed manually and/or tool-free, of the tool in at least one collision direction and/or to protect it during a collision process.

The at least one housing part can additionally or alternatively be arranged and formed to support a drive unit of the tool, in particular in the form of an electric motor, in at least one collision direction and/or to protect it during a collision process.

According to a further aspect of the present disclosure, it can be provided that the tool comprises a first housing part and a second housing part, wherein the first housing part and the second housing part are formed substantially symmetrically to a central plane of the tool, in particular to a central plane of a slot for the energy supply device, and/or are formed opposite to each other, wherein the functional structures each extend in sections substantially perpendicularly in the direction of the central plane and/or are spaced apart from the central plane, in particular in order to provide at least one access for an operating element of the tool.

According to a further aspect of the present disclosure, it can be provided that the first housing part and the second housing part each at a free end form an opening of the slot, in particular for inserting the energy supply device in an insertion direction, and that the functional structures of the first housing part and of the second housing part are each arranged at the free end in order to support an inserted energy supply device on a tool side adjacent and/or adjoining the opening during a collision process, and to absorb at least part of the impact energy and/or to dissipate it around the energy supply device.

This means that the energy supply device in particular, for example in the form of an accumulator on the basis of lithium-ions, can be better protected during the collision process in order to prevent damage to or destruction of the energy supply device.

The insertion direction can be a plug-in direction of the energy supply device.

According to a further general aspect, the present disclosure relates to a protective element for a portable tool, in particular for a portable motor-driven electric tool, for absorbing an impact energy during a collision process in an assembly state, wherein the protective element comprises at least one coupling section and at least one locking section for tool-free mounting, in particular for manual tool-free mounting, on at least one housing part of the tool, wherein the at least one coupling section is configured to form a first releasable connection with an associated mounting section of the at least one housing part, wherein the at least one locking section is configured to form a second releasable connection with an associated retaining section of the at least one housing part, and wherein the at least one coupling section is arranged and/or configured to perform a pivoting movement of the protective element about a pivot axis during mounting on the at least one mounting section.

In other words, the protective element is configured for pivot mounting on at least one housing part of the tool. In particular, the mounting comprises a releasable attachment and/or the formation of a releasable attachment. The at least one housing part can be formed as disclosed herein.

With the protective element according to the present disclosure, further improved impact and collision protection can be provided for the tool, with which the tool can optionally be equipped. The protective element is characterized above all by simple manual and above all tool-free mounting, which can also include manual tool-free disassembly.

In particular, the protective element represents an independent, external impact structure or collision structure for the portable tool, which can be used on the tool if required.

The first releasable connection can be a connection of the first type and the second releasable connection can be a connection of the second type, which is different from the first releasable connection.

It is possible that the at least one coupling section is configured to be partially attached and/or hooked onto the associated mounting section.

This ensures a defined retaining of the protective element on the at least one housing part right from the beginning of the mounting process, which also provides a defined guide for the protective element for further mounting, which in turn makes mounting easier.

In other words, the at least one coupling section is formed to be pluggably couplable and/or pivotably couplable to the mounting section. A hinge function between the at least one housing part and the protective element can be realized by (directly) hooking in the protective element by means of the at least one coupling section and the associated mounting section.

According to a further aspect of the present disclosure, it can be provided that the first releasable connection and/or the second releasable connection each comprises a substantially form-fit and/or a substantially force-fit connection or is at least formed as such, wherein in particular the second releasable connection comprises a plug-in connection and/or a snap-fit connection.

The snap-fit connection can be configured as a releasable snap-fit clamp connection, which can be formed during mounting by applying a compressive force with a defined minimum compressive force value to the protective element, i.e. in particular to the at least one locking section.

It is possible that the at least one coupling section and the at least one locking section are arranged at a distance from one another in a longitudinal direction of the protective element, with the at least one coupling section being arranged at an outer end of the protective element in the longitudinal direction.

This can ensure a robust and durable mounting of the protective element at intended points of the tool. On the other hand, an arrangement of the at least one coupling section at an outer end enables further simplified handling of the protective element in the course of mounting on the at least one housing part due to clear recognizability and assignment of the location of the at least one coupling section on the protective element.

The longitudinal direction can be a direction in which the protective element extends at its longest and therefore at its maximum dimensions.

According to a further aspect of the present disclosure, it can be provided that the at least one coupling section for forming an undercut for pivotably bearing the protective element comprises a projection, in particular a rib, which extends substantially transversely to a longitudinal direction of the protective element.

The formation of the undercut ensures, for example, that the protective element cannot slip off or accidentally come loose during mounting. This also makes it easier to hook in the protective element to the at least one coupling section.

According to a further aspect of the present disclosure, it can be provided that the protective element is curved with a substantially constant thickness and/or curved with a variable thickness at least in sections; and that the protective element is partially variable in shape, in particular deformable in a defined manner, and in particular reversibly deformable in a defined manner, in the area of the curvature up to a defined energy limit value for the impact energy.

For example, it is possible for the protective element to essentially return to its original shape, at least in sections, after a deformation process of the protective element in the course of or during a collision process. A curvature with an essentially constant thickness or with a varying thickness can be used to achieve a defined stiffness, for example depending on the configuration and formation of the tool.

It is possible that the protective element is essentially formed as a shell, as a hood or as a trough, which in each case merges in an edge area along a circumferential direction at least in sections into a contact flange for contacting the at least one housing part, wherein in particular the contact flange is characterized by a defined transition radius in order to dissipate and/or transfer at least part of the impact energy.

The protective element can be formed shell-shaped, hood-shaped or trough-shaped. The area of the contact flange with the defined transition area can in particular represent a curved area of the protective element.

The protective element can comprise a contact flange, which extends at least in sections in a circumferential direction and is configured to make contact with the at least one housing part in an assembly state.

In addition or alternatively, the protective element can comprise at least one deformation section in order to directly absorb at least part of the impact energy and to carry out a deformation, wherein the at least one deformation section is arranged relative to a contact flange of the protective element for contacting the at least one housing part, in particular in an assembly state of the protective element, and is formed to form a cavity relative to the at least one housing part in an assembly state of the protective element, in particular to form a gap with a constant distance or with a distance varying in a longitudinal direction of the protective element relative to the at least one housing part.

Via the deformation of the at least one deformation section, for example a significant part of the impact energy can already dissipate and thus be absorbed by the protective element. The contact flange can, for example, merge directly into the at least one deformation section and/or adjoin it and/or be arranged at a defined distance from the at least one deformation section.

It is understood that the contact flange and/or the at least one deformation section for forming the cavity can be formed substantially complementary and/or substantially identical and/or similar to the at least one housing part.

The at least one deformation section can be formed by walls and/or by wall sections of the protective element.

According to a further aspect of the present disclosure, it can be provided that the contact flange comprises at least one recess and/or at least one curvature along the circumferential direction, in each case for forming a cavity, in particular a gap, between the contact flange and the at least one housing part, in order to distribute the at least part of the impact energy at defined points of the at least one housing part in an assembly state.

It is possible that the protective element, in particular for forming at least a first deformation section and at least a second deformation section, comprises a first side wall and a second side wall, which are arranged at a distance from each other and/or opposite to each other, and each extend in a longitudinal direction of the protective element, wherein the first side wall and the second side wall are each formed flat and/or plate-shaped, and/or wherein the first side wall and the second side wall are arranged at an angle to each other.

According to a further aspect of the present disclosure, it can be provided that the first side wall and the second side wall are connected to each other via a common back wall which extends in a longitudinal direction of the protective element, wherein the first side wall, the second side wall and the back wall are formed as a grip shell for manual mounting of the protective element.

It is possible that the back wall is designed and/or arranged as a third deformation section.

It is possible that a reinforcing element is arranged in an inner area of the protective element on a back wall of the protective element, which is formed flat and/or plate-shaped, wherein in a longitudinal direction of the protective element the reinforcing element is arranged between the at least one mounting section and the at least one locking section.

According to a further aspect of the present disclosure, it can be provided that the protective element comprises at least one recess which is closed in a circumferential direction and/or which is half-open in a longitudinal direction of the protective element in order to form a defined stiffness of the protective element in each case and/or to enable access to at least one operating element of the tool in an assembly state.

It is possible that the protective element is integrally formed as one piece and/or that the protective element is formed from an elastic material, in particular by at least one injection process and/or by at least one casting process.

According to a further aspect of the present disclosure, it can be provided that, in a longitudinal direction of the protective element, a first side wall merges into a first shield and that a second side wall merges into a second shield, wherein the first shield and the second shield are spaced apart and/or arranged opposite to each other, and wherein the first shield and the second shield are each configured to bear and/or support the protective element in an assembly state in the direction of the pivot axis.

According to a further aspect of the present disclosure, it can be provided that the at least one locking section is formed as a U-shaped projection in a front view or comprises a U-shaped projection extending in a defined manner from a respective side wall of the protective element into an inner area of the protective element to form a latch element.

It is possible that the protective element is formed essentially symmetrical to a central plane.

According to a further general aspect, the present disclosure relates to a tool, in particular a portable motor-driven electric tool, with at least one first housing part, at least one second housing part, and with a protective element as disclosed herein, wherein the protective element is releasably mounted on the at least one first housing part and on the at least one second housing part, forming a preload, in order to form a clamping force between the at least one first housing part and the at least one second housing part, in particular substantially in the direction of the pivot axis.

Alternatively or additionally, it is possible that the clamping force is formed by the protective element between at least one first housing part, on which the at least one coupling section is formed, and at least one second housing part, on which the associated retaining section is formed.

The at least one first housing part and/or the at least one second housing part can be formed as disclosed herein.

The tool can be configured for operation with an exchangeable electrical power supply device, for example in the form of a manually tool-free mountable, exchangeable, rechargeable accumulator. The tool can be configured as disclosed herein.

The tool can comprise at least one housing part according to the disclosure with a functional structure as disclosed herein and a protective element according to the disclosure as disclosed herein. The functional structure, in particular the contact section, can be formed at least partially complementary to the protective element. At least one housing part according to the disclosure can be used together with the protective element according to the disclosure on a tool.

According to a further general aspect, the present disclosure can relate to an arrangement comprising a tool as disclosed herein, at least one housing part as disclosed herein and/or a protective element as disclosed herein.

The embodiments and features of the present disclosure described above can be combined with one another as desired.

### BRIEF DESCRIPTION OF THE DRAWINGS

Further or other details and advantageous effects of the present disclosure are explained in more detail below with reference to the accompanying figures.

FIG. 1 shows a first embodiment of the tool according to the present disclosure with two housing parts according to the present disclosure and with a power supply device in a perspective view, wherein a tool unit of the tool is hidden.

FIG. 2 is a sectional view (side view) of the tool from FIG. 1.

FIG. 3A shows an enlarged section of the tool from FIG. 1 (section V1).

FIG. 3B shows an enlarged section of the tool from FIG. 2 (section V2).

FIG. 4 is a perspective view of a section of the tool from FIG. 1 during a collision process.

FIG. 5 is a perspective view of a first embodiment of the protective element according to the present disclosure.

FIG. 6 is a front view (main view) of the protective element from FIG. 5.

FIG. 7 shows a perspective view of the tool from FIG. 1 and the protective element from FIG. 5 at the beginning of a mounting process.

FIG. 8A is a top view of the tool from FIG. 1.

FIG. 8B shows an enlarged section of the tool from FIG. 8A (section V3).

FIG. 9A is a sectional view (top view) of the tool from FIG. 1 with a mounted protective element from FIG. 5.

FIG. 9B shows an enlarged section of the tool and the protective element from FIG. 9A (section V4).

FIG. 10 is a side view of the tool from FIG. 1 with a mounted protective element from FIG. 5.

Identical or functionally equivalent devices, units or elements are marked with the same reference signs in the figures. For their explanation, reference is also made in part to the description of other embodiments and/or figures in order to avoid repetitions.

### DETAILED DESCRIPTION OF THE DISCLOSURE

The following detailed description of the embodiments shown in the figures serves to illustrate or clarify in more detail and is in no way intended to limit the scope of the present disclosure.

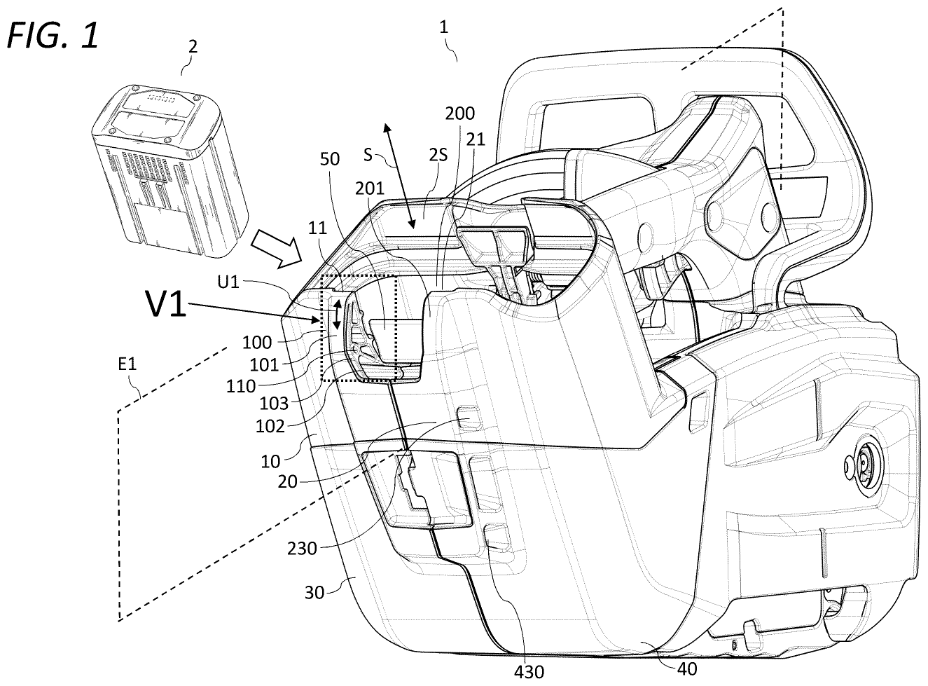

FIG. 1 shows a first embodiment of the tool 1 according to the present disclosure with two housing parts 10, 20 according to the present disclosure and with a power supply device 2 of the tool 1 in a perspective view.

The tool 1 can be a mobile, a portable, a manually operable, a self-contained (mains-independent) and/or a motor-driven electric tool. For example, the tool 1 can be formed as one of the following: a garden tool, for example in the form of a trimmer, a shears, a scythe, a blower, a brush cutter; a forestry tool, for example in the form of a chainsaw; a cleaning tool, for example in the form of a high-pressure cleaner; a blower or a vacuum cleaner; another electrical tool, for example in the form of a drill, a grinder, a saw, a vacuum cleaner, a compressor. Further formations and configurations of the tool 1 are possible.

In the embodiment shown, the tool 1 is a portable motor-driven electric tool in the form of a chainsaw operated by an electric motor, although a saw chain and an associated guide bar for the saw chain as a tool unit of the tool 1 are not shown for reasons of clarity. The chainsaw 1 is a so-called pruning saw.

The energy supply device 2 is formed as a separate device and is configured to supply electrical energy to the tool 1. The energy supply device 2 can be formed as a portable, manually mountable and/or exchangeable accumulator and can, for example, comprise a plurality of lithium-ion cells.

The tool 1 comprises a first housing part 10 and a second housing part 20. In addition, the tool 1 comprises further housing parts for forming a tool housing of the tool 1, of which the further housing parts 30 and 40 are marked for reasons of clarity. The housing parts 10, 20, 30, 40 serve, among other things, to accommodate devices and/or tool units, as well as to protect them from external influences, in particular mechanical loads in the form of shocks in the course of collisions. It is understood that the tool 1 comprises corresponding tool units, for example a control unit, an electric motor, a lubricant tank for the saw chain, a hand guard, a handle tube, an operating handle with operating elements, etc., in order to realize its intended function.

The housing parts 10 and 20 are each in themselves formed half-shell-shaped and, in an assembly state of the tool 1, form a slot 2S for releasable receiving the energy supply device 2 in an insertion direction S as the mounting direction of the energy supply device 2. In other words, the housing parts 10 and 20 form a so-called hood of the tool 1. In a state inserted into the slot 2S and thus in an assembly state, the energy supply device 2 can be both locked and released within the tool housing and in particular within the housing parts 10 and 20 by means of a manually operable operating element 50 in the form of a pivotably supported locking lever. A further operating element for locking and releasing the energy supply device 2 in the form of a locking lever is provided, but is not marked for reasons of clarity. Both the housing parts 10 and 20 and the operating elements 50 are formed and/or arranged essentially symmetrically with respect to a central plane E1 of the tool 1.

Due to their mass, the tool 1 and the energy supply device 2 are characterized by a respective weight and result in a total weight in an assembly state, wherein the energy supply device 2 contributes a significant, i.e. non-negligible, proportion to the total weight. Due to the mass and the resulting total weight, the tool housing in particular must be formed and configured accordingly in order to realize, among other things, a protective function with respect to the energy supply device 2 and other tool units accommodated.

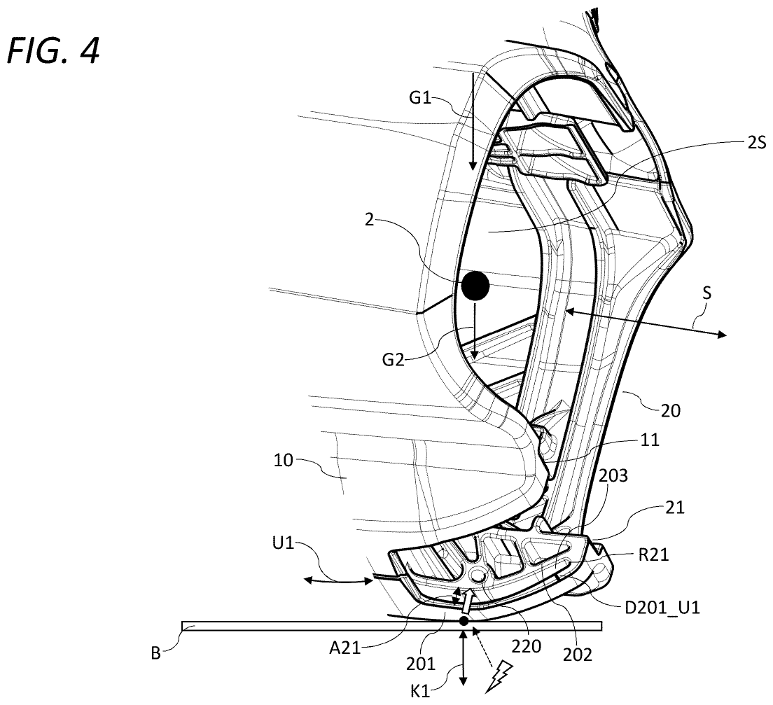

Since the tool 1 is a portable and manually operable tool 1, which is also used at corresponding working heights (see also FIG. 4), the tool 1 can be subjected to a collision, i.e. an impact and thus a short-term mechanical shock load. For example, when the tool 1 is dropped, there can be a collision process with a floor B, which generates an impact energy that is essentially absorbed by the tool 1 during the collision process.

To protect the tool units and devices arranged inside the tool housing, in particular the energy supply device 2, from damage or destruction, in the present embodiment both the housing part 10 and the housing part 20 each comprise a functional structure 100, 200 for absorbing an impact energy during a collision process in a collision direction K1 onto a floor B (see also FIG. 4).

The features of the functional structure 100 described below apply accordingly to the functional structure 200 and vice versa.

The functional structure 100 represents an impact structure or collision structure integrated into the housing part 10, and the functional structure 200 represents an impact structure or collision structure integrated into the housing part 20. FIG. 1 primarily shows the functional structure 100 and its formation. The functional structure 100 comprises a contact section 101, which is arranged and configured to directly (immediately) absorb the impact energy and perform a deformation. The contact section 101 thus represents a deformation section, i.e. a deformation wall of the functional structure 100, which is correspondingly geometrically formed and/or made of a material in order to directly (immediately) absorb the impact energy and dissipate it by deformation.

The functional structure 100 comprises a deformation zone 103, which is arranged at the contact section 101 and configured to receive a deformation of the contact section 101. The functional structure 100 comprises a stop section 102, which is arranged and configured to limit the deformation of the contact section 100 and to transfer and/or distribute at least part of the impact energy, namely to further walls and/or wall sections of the housing part 10, the housing part 20 and/or also to further housing parts 30, 40 of the tool housing.

In the present embodiment, the contact section 101 and the stop section 102 are each rib-shaped or band-shaped and extend along a circumferential direction U1. The circumferential direction U1 can in particular be an outer circumferential direction U1 which runs along an extension of the contact section 100, in particular resulting and/or idealized in a plane (not shown in the figures) which is essentially parallel to the central plane E1. As can be seen from FIG. 1, the functional structure 100 is formed half-open in a direction substantially perpendicular to the central plane E1.

The deformation zone 103 is arranged between the contact section 101 and the stop section 102 and represents a cavity. It is possible that the deformation zone 103 is at least partially filled with a filling material, wherein the filling material is configured to dampen and/or delay the deformation of the contact section 101. The filling material can be a foam material, for example. The functional structure 100 is formed sandwich-shaped, at least in sections, and represents a so-called crumple zone.

A reinforcing element 110 is arranged and/or formed on the stop section 102, as well as further walls and/or wall sections which extend in the direction of the slot 2S as ribs, struts, channels, beads and/or webs.

A mounting section 11 is formed on the first housing part 10 and a mounting section 21 is formed on the second housing part 20. Furthermore, the retaining sections 230 and 430 are visible on the housing parts 20 and 40.

The mounting sections 11 and 21, together with the retaining sections 230 and 430, are used to mount a separate protective element 3 to the tool housing, i.e. to the housing parts 10, 20, 30, 40.

The protective element 3 and the housing parts 10, 20, 30, 40 are described in more detail below with reference to further figures. The functional structure 100 is described in more detail below with reference to section V1.

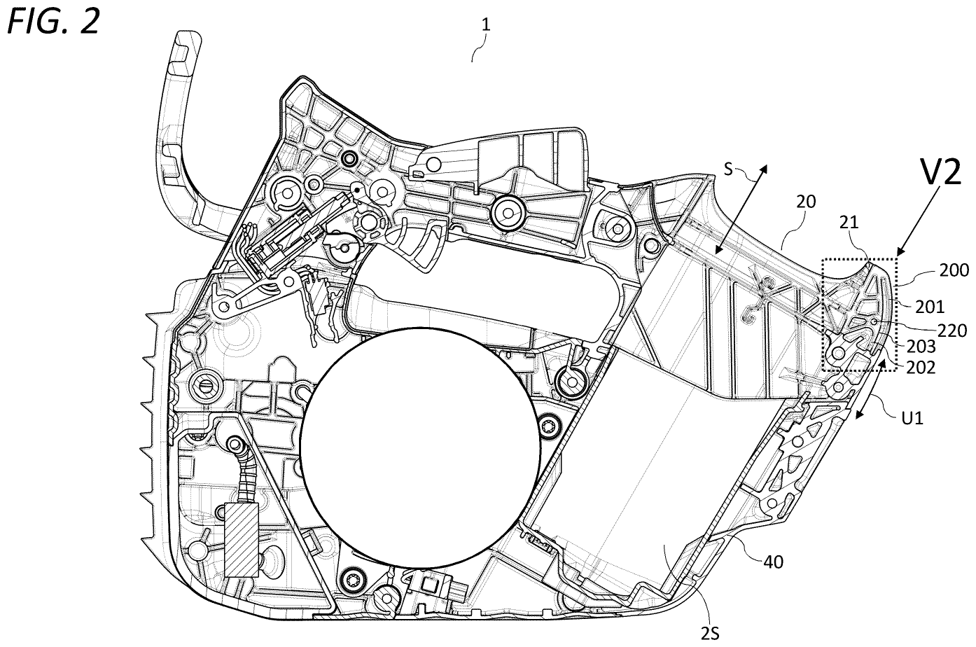

FIG. 2 shows the tool 1 from FIG. 1 in a sectional view (side view). FIG. 2 shows the functional structure 200 in a front view (main view). The slot 2S used to receive the energy supply device 2 is clearly recognizable, which is defined in its opening area by the housing part 20 with corresponding ribs, webs and/or struts to increase the stiffness in a defined manner.

The functional structure 200 is formed analogously to the functional structure 100 and comprises the contact section 201, the stop section 202 and the deformation zone 203. Furthermore, the reinforcing element 220 is arranged and/or formed on the stop section 202. The functional structure 200 is described in more detail below with reference to section V2.

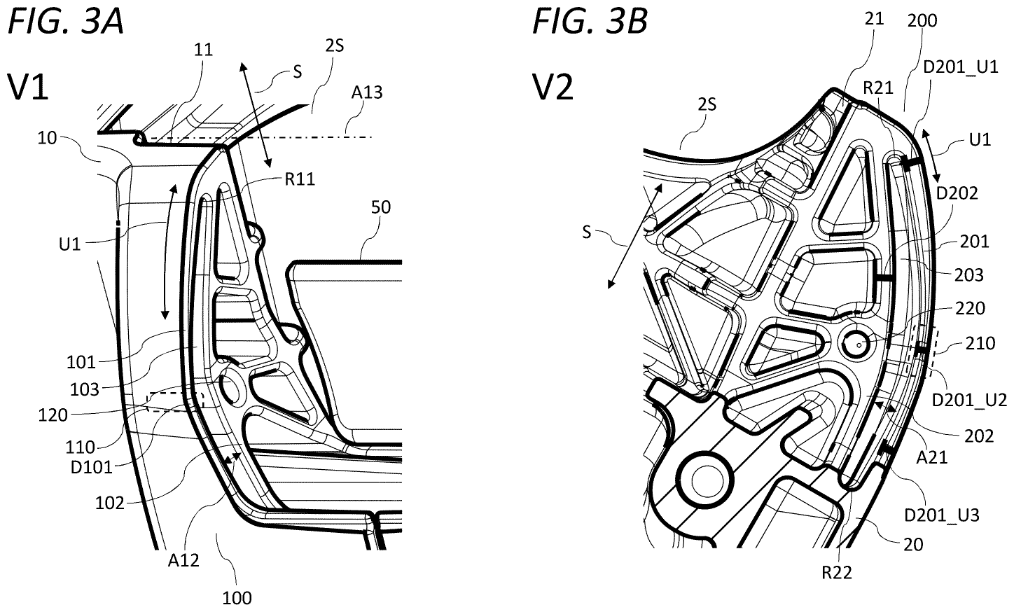

FIG. 3A shows an enlarged section of the tool 1 from FIG. 1, i.e. section V1, in which essentially the functional structure 100 is shown in a perspective view.

As a special wall section or deformation section of the functional structure 100, the contact section 101 is formed partially variable in shape, in particular up to a defined energy limit value for the impact energy. The contact section 101 can be configured to carry out the deformation reversibly in order to essentially return to an original shape after a collision process. The energy limit value for the impact energy can, for example, be defined by a drop height of the tool 1 with integrated, i.e. mounted, energy supply device 2.

Due to the arrangement of the deformation zone 103 between the contact section 101 and the stop section 102, a distance A12 is formed between the contact section 101 and the stop section 102, which characterizes the deformation zone 103 in at least one direction and defines and/or limits a maximum deformation of the contact section 101 in at least one direction. The stop section 102 is formed essentially dimensionally stable, in particular up to a defined energy limit value for the impact energy. In other words, the stop section 102 represents an essentially rigid or deformation-resistant stop structure, which serves to limit the deformation of the contact section 102 in at least one deformation direction.

The distance A12 can be essentially constant or vary along an extension of the deformation zone 103 in the circumferential direction U1 and in particular assume a defined maximum value.

In the present embodiment, the contact section 101 comprises a predetermined breaking point 110, the location of which is indicated by a dashed line. The predetermined breaking point 110 is configured to cause a defined break, in particular a forced break, of the contact section 101 when a defined energy limit value for the impact energy is reached and/or exceeded. The predetermined breaking point 110 is locally limited at the contact section 101, in particular in the circumferential direction U1. The predetermined breaking point 110 is characterized, for example, by a corresponding material and/or by a corresponding thickness D101 of the contact section 101 in this area.

The contact section 101, the deformation zone 103 and the stop section 102 are each formed curved in a common direction, in particular curved outwards in relation to the tool 1. This can, for example, further increase the stiffness of the functional structure 100, while the functional structure 100 retains its function as a crumple zone for the tool 1.

At a first end of the functional structure 100, the contact section 101 merges into the stop section 102 via the transition R11. In particular, the transition R11 can be a rounded transition. Accordingly, at a second end, which is not visible in FIG. 3A, the functional structure 100 can merge into the stop section 102 via a further rounded transition.

The reinforcing element 120 is configured to further increase a stiffness of the stop section 102 and, in particular, to at least partially absorb and/or substantially neutralize a torsional load occurring during the collision process, wherein the reinforcing element 120 is arranged and/or formed on the stop section 102 on a side opposite the deformation zone 103. The reinforcing element 120 is formed hollow shaft-shaped or tubular in sections and extends substantially perpendicular to the circumferential direction U1 and/or to at least one deformation direction of the contact section 101. Furthermore, respective ribs, struts, channels and/or webs of the housing part 10 extend away from the reinforcing element 120 in the direction of the slot 2S, which are not marked in more detail for reasons of clarity.

FIG. 3B shows an enlarged section of the tool 1 from FIG. 2, i.e. section V2, in which essentially the functional structure 200 can be seen in a front view (main view).

The front view shows the course of the contact section 201, the stop section 202 and the deformation zone 203 along the circumferential direction U1. In this view, the deformation zone 203 is characterized by an arc-segment shaped outline with rounded transitions R21 and R22 between the contact section 201 and the stop section 202, in particular in at least one deformation direction of the contact section 201, in order to transfer at least part of the impact energy to the stop section 202 without damaging or destroying the transfer point.

Along the extension of the contact section 201 in the circumferential direction U1, a thickness D201_U1 of the contact section 201 at a defined first circumferential position decreases from a defined maximum value to a thickness D201_U2 of the contact section 201 at a defined second circumferential position with a defined minimum value, in particular steadily decreases, and then in the further course increases to a thickness D201_U3 of the contact section 201 at a defined third circumferential position, in particular steadily increases. The defined maximum value can, for example, be identical to a regular and/or standardized wall thickness of a wall section of the housing part 20, which is used to support the energy supply device 2 in an assembly state. In FIG. 3B, at least one such wall section adjoins the functional structure 200 in the direction of the slot 2S, with two half-open cavities with a triangular outline being formed between the wall section and the stop section, for example.

As a result, a formation of the contact section 201 is realized which is configured at the defined second circumferential position and/or in the area of the second defined circumferential position for a maximized deformation of the contact section 201.

The contact section 201 can have a stiffness that is different to the stiffness of the stop section 202, in particular is less than the stiffness of the stop section 202, whereby the contact section 201 qualifies as a deformation section of the functional structure 200. Alternatively, a thickness D201 of the contact section 201 can be substantially constant along the circumferential direction.

A thickness D202 of the stop section 202 can be at least equal to or greater than a thickness D201 of the contact section 201 with a defined maximum value.

It can also be seen from the illustration in FIG. 3B that the functional structure 200 is formed to be half-open and/or free of undercuts in a direction substantially perpendicular to the central plane E1 and/or in a direction substantially perpendicular to the circumferential direction U1.

FIG. 4 shows a perspective view of a section of the tool 1 from FIG. 1 during a collision process. Due to its resulting mass, an energy supply device 2 received in the slot 2S is marked idealized point shaped with the weight force G2, which acts in the direction of the floor B. A resulting and/or idealized weight force G1 of the tool 1 without energy supply device 2 is also shown.

The collision process takes place in the resulting and/or idealized collision direction K1 and affects the contact section 201 of the functional structure 200, which makes contact with the floor B.

The impact energy occurring and/or arising in this case results, among other things, from a total weight force (“total weight”) of the tool 1 and the energy supply device 2 and thus from the sum of the weight forces G1 and G2. The impact energy is absorbed by the functional structure 200, wherein the contact section 201 is at least partially deformed during the collision process within the deformation zone 203 in the direction of the stop section 202, which is indicated by a corresponding arrow in FIG. 4. Due to the deformation of the contact section 201 in the deformation zone 203, at least part of the impact energy is absorbed and thus dissipated. The stop section 202 limits the deformation of the contact section 201, but remains in an essentially unchanged state, essentially dimensionally stable, with regard to its shape due to sufficient stiffness.

At least a further part of the impact energy can be transferred and/or distributed to the stop section 202 via the transitions R21 and R22.

Due to the properties and relationships between the contact section 201, the stop section 202 and the deformation zone 203 described herein, an effective functional structure 200 is provided in terms of collision behaviour or impact behaviour, by which the housing part 20 is characterized and which serves in particular to protect the energy supply device 2 from damage or destruction. The same applies to the housing part 10 with the functional structure 100.

The housing part 20 with the functional structure 200 is integrally formed in one piece as a single part. The housing part 20 can be formed by at least one injection process, at least one casting process and/or by at least one laminating process. In particular, the stop section 202 can be formed from a material based on a fiber-reinforced plastic.

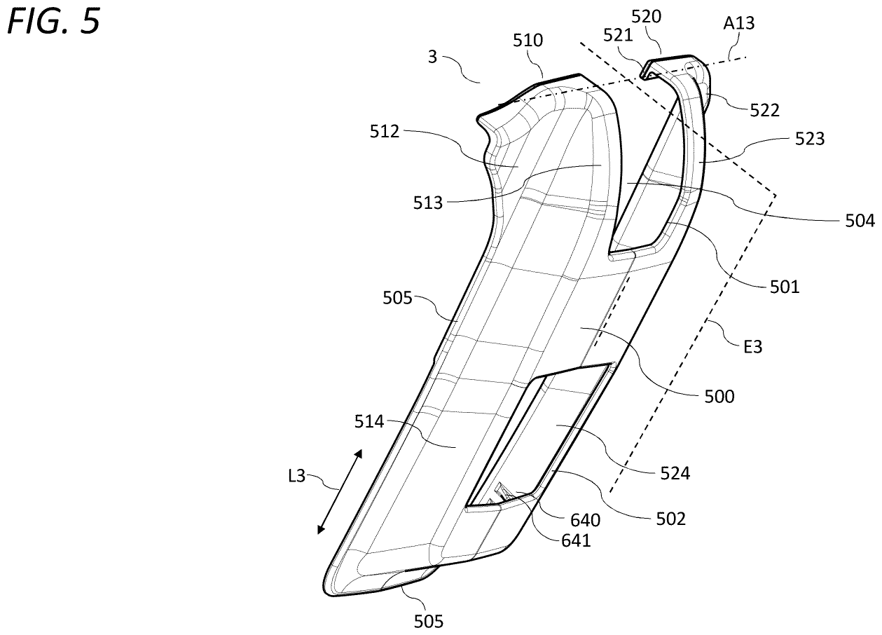

FIG. 5 shows a perspective view of a first embodiment of the protective element 3 according to the present disclosure.

The protective element 3 is configured to be mounted to a portable tool 1 as disclosed herein and, in an assembly state, serves to absorb an impact energy during a collision process in order to realize an extended protection for the tool element 1. In other words, the protective element 3 for the tool 1 constitutes an additional and/or external collision structure or impact structure, which serves to protect the tool housing, in particular at least the housing parts 10, 20, 30, 40 and furthermore the devices 2 and/or tool units accommodated inside the tool housing.

The protective element 3 is configured for manual and/or tool-free mounting to the housing parts 10, 20, 30, 40 and for this purpose comprises two coupling sections 510 and 520, as well as four locking sections 610, 620, 630, 640, of which the locking section 640 is visible in FIG. 5 next to the coupling sections 510 and 520. A coupling section 510, 520 is configured in each case to form a releasable connection 11, 510 and 21, 520 of a first type with a respectively associated mounting section 11 and 21. The mounting sections 11 and 21 are formed on the housing parts 10 and 20 and are visible, for example, in FIGS. 1 and 4. The mounting sections 11 and 21 can each be formed as an edge or as a flange.

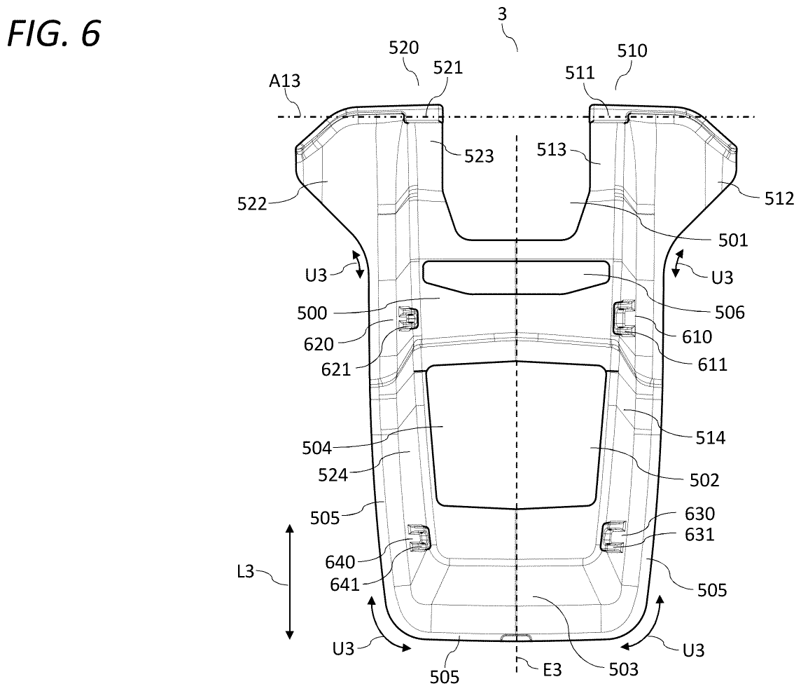

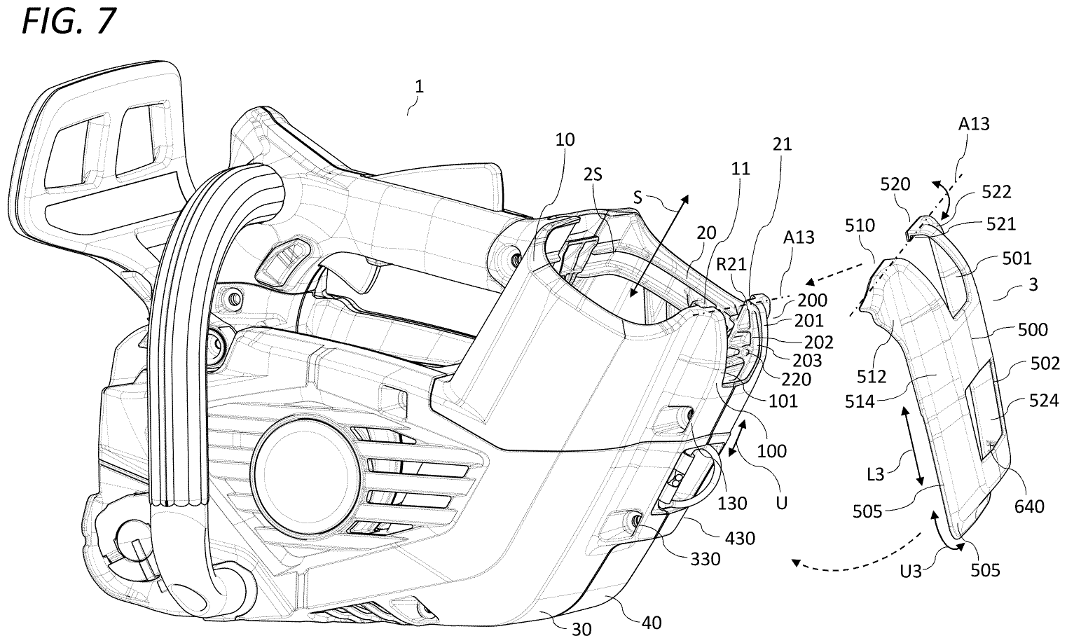

The locking sections 610, 620, 630, 640 (see FIG. 6) serve to form releasable connections 130, 610; 230, 620; 330, 630 and 430, 640 of a second type with (respectively) associated retaining sections 130, 230, 330, 430, which are formed on the respective housing parts 10, 20, 30, 40. The retaining sections 230 and 430 are visible in FIG. 1, whereas the retaining sections 130 and 330 are visible in FIG. 7. Each retaining section 130, 230, 330, 430 is formed on the respective housing part 10, 20, 30, 40 and is part of a screw dome, among other things.

FIG. 6 shows the protective element 3 from FIG. 5 in a front view (main view) for closer illustration, in which the locking sections 610, 620, 630, 640 are visible, among other things.

The releasable connections 11, 510 and 21, 520 of the first type to be formed and/or formed, as well as 130, 610; 230, 620; 330, 630 and 430, 640 of the second type are each essentially form-fit connections, in particular plug-in connections or plug-in/hang-in connections. The releasable connections 130, 610; 230, 620; 330, 630 and 430, 640 of the second type to be formed and/or formed are furthermore essentially force-fit connections, in particular in the form of releasable snap-fit clamp connections. The snap-fit clamp connections 130, 610; 230, 620; 330, 630 and 430, 640 can be formed by applying a sufficient (external) mounting pressure force to the protective element 3 in the course of mounting on the housing parts 10, 20, 30, 40. Furthermore, it is possible to release the snap-fit clamp connections 130, 610; 230, 620; 330, 630 and 430, 640 by applying a sufficient mounting tensile force to the protective element 3 during disassembly in order to remove the protective element 3 from the housing parts 10, 20, 30, 40.

For forming a locking-clamping connection 130, 610; 230, 620; 330, 630 and 430, 640 with the respectively associated retaining section 130, 230, 330, 430 of the respective housing part 10, 20, 30, 40, each locking section 610, 620, 630, 640 comprises a latch element 611, 621, 631, 641 in the form of a projection, which is formed U-shaped in a respective front view and which extends in a defined manner from a respective side wall 514, 524 of the protective element 3 into an inner area 504 of the protective element 3. The respective latch element 611, 621, 631, 641 is located in an assembly state of the protective device 3 on and/or in the associated retaining section 130, 230, 330, 430, i.e. within the respective screw dome, wherein a clamping force is additionally formed in order to adequately fasten the protective element 3.

The coupling sections 510, 520 and the locking sections 610, 620, 630, 640 are arranged at a distance from one another in a longitudinal direction L3 of the protective element 3, wherein the coupling sections 510, 520 are arranged at an outer end of the protective element 3 in the longitudinal direction L3. The longitudinal direction L3 is in particular a direction in which the protective element 3 extends at its longest and thus at its maximum with regard to its dimensions.

The coupling sections 510 and 520 are configured to perform a pivoting movement of the protective element 3 about a pivot axis A13 during mounting on the associated mounting sections 11 and 21. In particular, the coupling sections 510 and 520 are configured to be partially plugged and/or hooked onto the associated mounting sections 11 and 21. Each coupling section 510 and 520 comprises a projection 511 and 521 to form an undercut for the pivotable bearing of the protective element 3, of which the projection 521 of the coupling section 520 is visible in FIG. 5. The projections 511 and 522 each extend substantially transversely to the longitudinal direction L3 of the protective element 3 and/or substantially in the direction of the pivot axis A13. In particular, the projections 511 and 521 are each formed as a rib. The pivot axis A13 is defined in particular by the coupling sections 510, 520 and the associated mounting sections 11, 21. The coupling sections 510, 520 and the associated mounting sections 11, 21 are formed essentially complementary to each other. In other words, the protective element 3 is configured for pivotal mounting to the tool housing of the tool 1, which comprises the housing parts 10, 20, 30, 40. In particular, this ensures simple mounting of the protective element 3 in the form of a pivotal movement and a subsequent locking process, in which the protective element 3 is first plugged and/or hooked in an inclined location via the coupling sections 510, 520 to the associated mounting sections 11 and 21 for pivotable bearing. The protective element 3 can then be mounted on the housing parts 10, 20, 30, 40 as part of a pivoting process about the pivot axis A13 by forming the locking-clamping connections 130, 610; 230, 620; 330, 630 in a releasable yet sufficiently secure manner.

The protective element 3 comprises a contact flange 505, which extends at least in sections in a circumferential direction U3 of the protective element 3 and is configured for contacting the housing parts 10, 20, 30, 40 in an assembly state of the protective element 3. The contact flange 505 can comprise at least one recess and/or at least one curvature along the circumferential direction U3 in each case for forming a cavity, in particular a gap, between the contact flange 505 and the respective housing part 10, 20, 30, 40 in order to transmit and/or distribute the at least part of the impact energy at defined points of the housing parts 10, 20, 30, 40 in an assembly state.

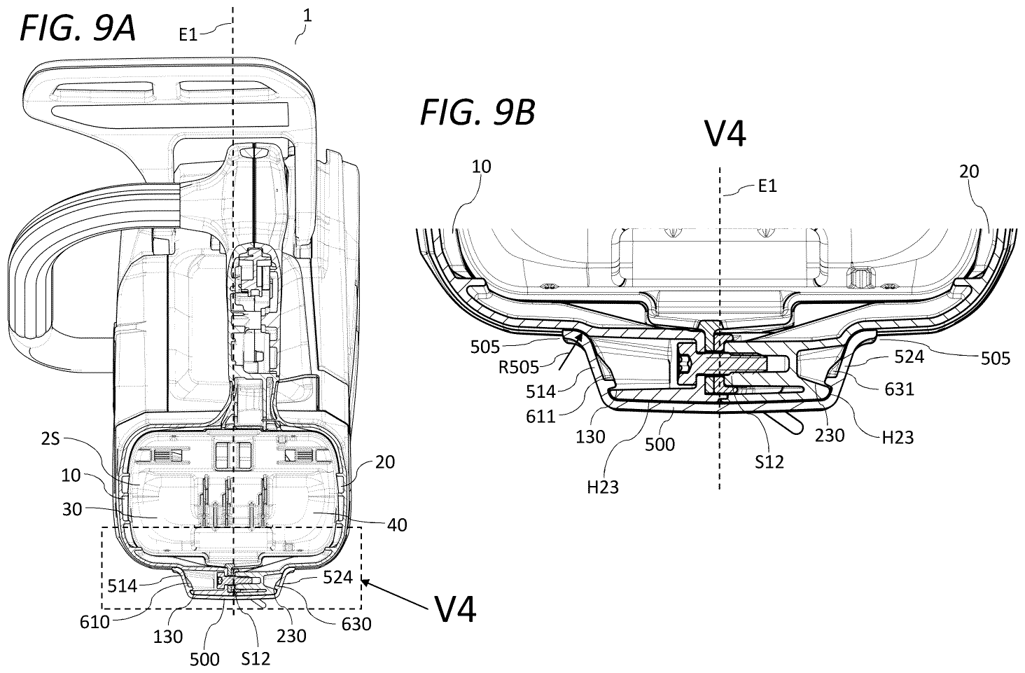

Furthermore, the protective element 3 comprises a plurality of deformation sections 500, 503, 514, 524 in the form of walls and/or wall sections, of which the deformation sections 503, 514 and 524 are formed as side walls of the protective element 3 and the deformation section 500 is formed as a back wall of the protective element 3, in order to directly (immediately) absorb at least a part of the impact energy in an assembly state during a collision process and to at least partially carry out a deformation. The deformation sections 500, 503, 514, 524 are each arranged and/or formed in relation to the contact flange 505 by a defined location and/or dimension to form a cavity H23 (see FIG. 9A) to the respective housing parts 10, 20, 30, 40 in an assembly state of the protective element 3, in particular in each case at least one gap H23 with a constant distance or with a distance varying in the longitudinal direction L3 of the protective element 3 to the housing parts 10, 20, 30, 40, that is to say to the outer surfaces thereof. This provides a further, additional deformation option for the deformation sections 500, 503, 514, 524 in an assembly state of the protective element 3, which leads to further improved protection of the tool 1 during a collision process. Additional explanations can be found below with reference to the description of FIGS. 9A and 9B.

The protective element 3 comprises a first deformation section 514 in the form of the first side wall 514 and a second deformation section 524 in the form of the second side wall 524, which are arranged at a distance from and/or opposite to each other and each extend in the longitudinal direction L3 of the protective element 3. The first side wall 514 and the second side wall 524 are each formed substantially flat and/or plate-shaped. The first side wall 514 and the second side wall 524 are arranged at an angle to one another.

Furthermore, the first side wall 514 and the second side wall 524 are connected to each other via a third side wall 503 and via a common back wall 500 as further deformation sections 503 and 500. The back wall 500 extends in the longitudinal direction L3 of the protective element 3.

The first side wall 514, the second side wall 524 and the back wall 500 are in particular formed as a grip shell for manual mounting of the protective element 3. The protective element 3 can be formed as a trough, a shell or a hood.

The protective element 3 comprises a recess 502, which is formed closed on the back wall 500 in a circumferential direction, and a recess 501, which is formed half-open in the longitudinal direction L3 of the protective element 3 in order to form each a defined stiffness of the protective element 3 and/or to allow access to the operating element 50 of the tool 1 in an assembly state.

The half-open recess 501 is limited in the direction of the pivot axis A13 by the first side wall 514 and by the second side wall 524, which in the area of the half-open recess 501 along the longitudinal direction L3 form the shape of a skid 513, 523 or are characterized by a skid-shaped course. In addition, along the longitudinal direction L3, the first side wall 514 merges into a first shield 512 and the second side wall 524 merges into a second shield 522. The first shield 512 and the second shield 522 are arranged at a distance from and/or opposite to each other and are each configured to bear and/or support the protective element 3 in an assembly state in the direction of the pivot axis A13, which leads to a further improved attachment of the protective element 3 to the tool 1.

Furthermore, the protective element 3 can additionally comprise a reinforcing element 506 in its inner area 504, which is, for example, formed plate-shaped and arranged on the back wall 500. The reinforcing element 506 can contribute to dissipating and/or transferring at least part of the impact energy in at least one defined direction.

In particular, the protective element 3 is integrally formed in one piece as a single part. The protective element 3 can be formed from an elastic material, for example on the basis of a plastic, in particular by at least one injection process and/or by at least one casting process.

FIG. 7 shows a perspective view of the tool 1 from FIG. 1 and the protective element 3 from FIG. 5 at the beginning of a mounting process. The mounting process of the protective element 3 is shown schematically with dashed arrow lines. The protective element 3 is plugged and/or hooked onto the associated mounting sections 11 and 21 of the housing parts 10 and 20 by means of the coupling sections 510 and 520 and then pivoted to the housing parts 10, 20, 30, 40 tool-free and/or manually until the latch elements 611, 621, 631, 641 engage with the associated retaining sections 130, 230, 330, 430 to form respective releasable locking-clamping connections 130, 610; 230, 620; 330, 630; 430, 640, so that the contact flange 505 contacts with the housing parts 10, 20, 30, 40 and the protective element 3 thus rests against the tool housing.

It is possible that the protective element 3 is configured for releasable mounting with the formation of a preload in order to form a clamping force between the housing parts 10 and 20, 10 and 30, 10 and 40, 20 and 30, and/or 20 and 40. This improves the attachment of the protective element 3 to the tool 1 and makes it more resistant, for example, to vibrations occurring in an operating state of the tool 1.

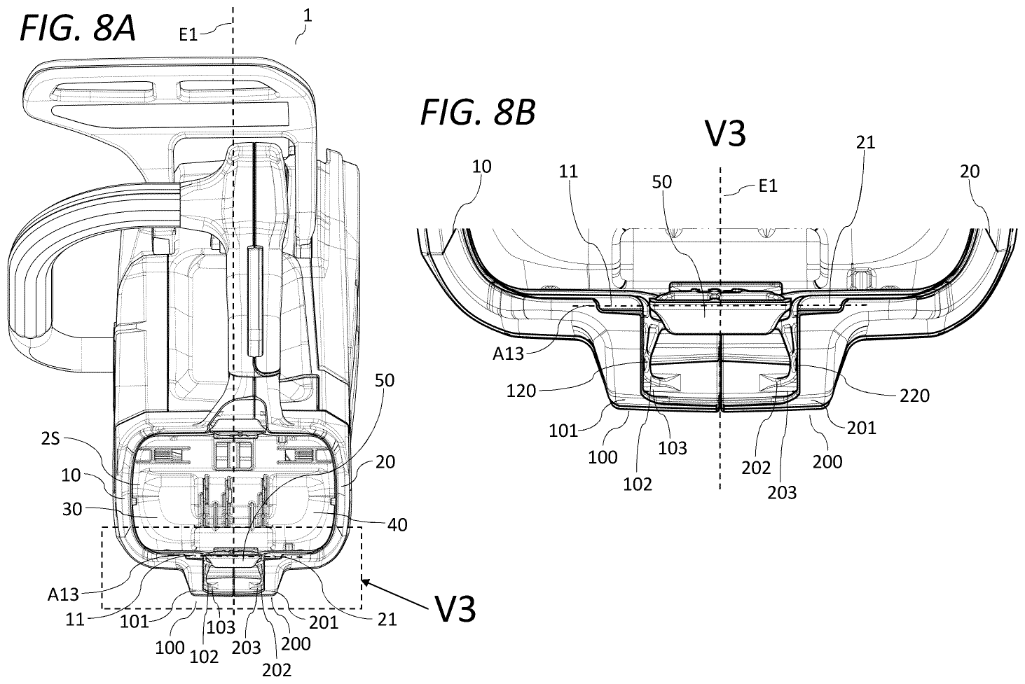

FIG. 8A shows a top view of the tool 1 from FIG. 1. The half-shell shaped formation of the housing parts 10 and 20, the interior of the slot 2S with the plate-shaped contact elements for receiving and connecting the energy supply device 2, as well as the outer formation and arrangement of the functional structures 100 and 200, which lead to a curvature and/or bulge of the tool housing, are clearly recognizable.

FIG. 8B shows an enlarged section of the tool 1 from FIG. 8A, i.e. section V3.

The location and formation of the contact sections 101, 201, the stop sections 102, 202 and the deformation zones 103, 203 each located in between are clearly recognizable. The illustration in FIG. 8B graphically shows that the functional structures 100 and 200 are formed and/or arranged essentially symmetrically with respect to the central plane E1.

The functional structures 100, 200 extend in sections substantially perpendicular to the central plane E1 and/or are arranged at a distance from the central plane E1 in order to provide access to the operating element 50 of the tool 1 for manual operation.

FIG. 9A shows the tool 1 from FIG. 1 with a mounted protective element 3 from FIG. 5 in a sectional view (top view).

FIG. 9B shows an enlarged section of the tool 1 and the protective element 3 from FIG. 9A, i.e. section V4.

The protective element 3 is in an assembly state, which can be recognized, among other things, by the formed, visible locking-clamping connections 130, 610 and 230, 630 between the locking sections 610, 620 and the associated retaining sections 130 and 230.

The contact flange 505 makes contact with the housing parts 10, 20, 30, 40. The transition between the first side wall 514 and the contact flange 505 is characterized by the transition radius R505. The same applies to the transition between the second side wall 524 and the contact flange 505, although this is not marked in more detail in FIG. 9B for reasons of clarity.

Furthermore, it can be seen from the illustrations in FIGS. 9A and 9B that the housing parts 10 and 20 are connected with each other via the screw connection S12, the respective associated screw dome forming the retaining section 130 and 230 associated with the locking sections 610 and 630 or at least being a component thereof.

The side walls 514, 524 and/or the back wall 500 are arranged and/or formed together with the contact flange 505, so that a cavity H23, in particular in the form of a gap H23, is formed between the respective walls 514, 524, 500 and the associated housing parts 10, 20, 30, 40, i.e. their outer surfaces, in the assembly state of the protective element 3. In FIG. 9B, the location of the cavity H23 between the protective element 3, i.e. the inner side of the back wall 500, and the tool housing, i.e. the housing parts 10 and 20, is indicated.

The cavity H23 is available as a deformation zone for the walls 514, 524 and 500, which act as deformation sections, to absorb a respective deformation during a collision process and thereby already absorb at least part of the impact energy.

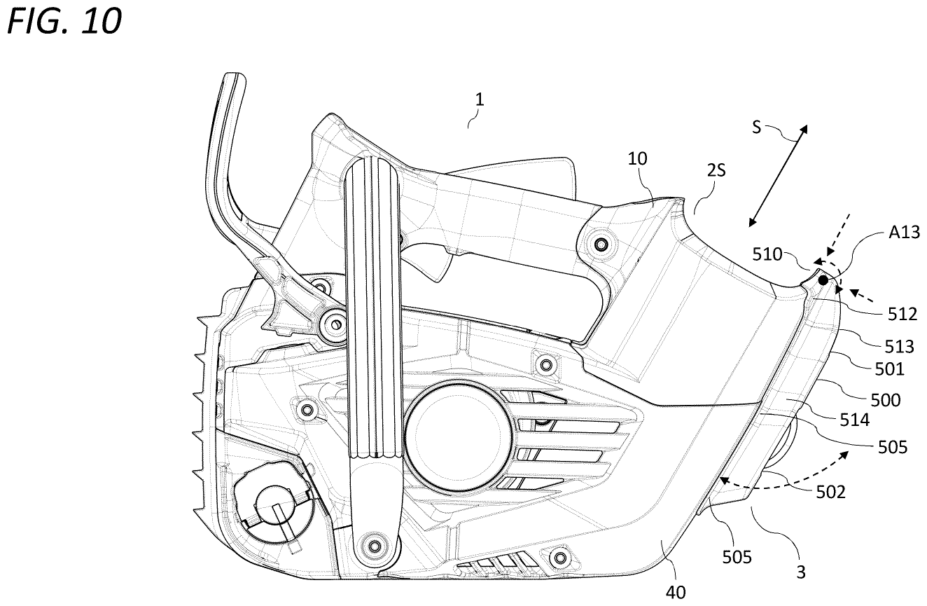

FIG. 10 shows a side view of the tool 1 from FIG. 1 with a mounted protective element 3 from FIG. 5.

The present disclosure is not limited to the embodiments described above. Rather, a large number of variants and modifications are possible which also make use of the inventive concept and therefore fall within the scope of protection. In particular, the present disclosure also claims protection for the subject matter and features of the subclaims independently of the claims referred to.

### LIST OF REFERENCE SYMBOLS

1 tool
2 energy supply device
3 protective element
2S slot
10 housing part
11 mounting section
20 housing part
21 mounting section
30 housing part
40 housing part
50 operating element
100 functional structure
101 contact section
102 stop section
103 deformation zone
110 predetermined breaking point
120 reinforcing element
130 retaining section
200 functional structure
201 contact section
202 stop section
203 deformation zone
210 predetermined breaking point
220 reinforcing element
230 retaining section
330 retaining section
430 retaining section
500 back wall
501 recess
502 recess
503 side wall
504 inner region area
505 edge area
506 reinforcing element
510 coupling section
511 projection
512 shield
513 skid
514 side wall
520 coupling section
521 projection
522 shield
523 skid
524 side wall
610 locking section
611 latch element
620 locking section
621 latch element
630 locking section
631 latch element
640 locking section
641 latch element
A13 pivot axis
A12 distance
A21 distance
B floor
D101 thickness
D201_U1 thickness
D201_U2 thickness
D201_U3 thickness
D202 thickness
G1 weight force
G2 weight force
E1 central plane
E3 central plane
H23 cavity
K1 collision direction
L3 longitudinal direction
R11 transition
R21 transition
R22 transition
R505 transition radius
S insertion direction
S12 screw connection
U1 circumferential direction
U3 circumferential direction

What is claimed is:

1. A housing part for a portable tool or for a power supply device of a portable electric tool, comprising:
a functional structure for absorbing an impact energy during a collision process,
wherein the functional structure comprises a contact section arranged and configured to directly absorb the impact energy and to undergo deformation,
wherein the functional structure comprises a deformation zone arranged at the contact section and configured to receive the deformation of the contact section, and
wherein the functional structure comprises a stop section arranged and configured to limit the deformation of the contact section and to transfer at least a portion of the impact energy.

2. The housing part according to claim 1,
wherein the stop section is formed to be dimensionally stable to distribute the at least a portion of the impact energy; or
wherein the contact section is formed to be partially variable in shape and is configured to undergo reversible deformation.

3. The housing part according to claim 1,
wherein the deformation zone is arranged between the contact section and the stop section so that a distance is formed between the contact section and the stop section,
wherein the distance is either constant or variable along an extension of the deformation zone in a circumferential direction.

4. The housing part according to claim 1,
wherein the contact section comprises at least one predetermined breaking point configured to cause a defined breakage of the contact section when a defined threshold value of the impact energy is reached or exceeded.

5. The housing part according to claim 1,
wherein the contact section, the deformation zone and/or the stop section are each formed with a curvature in a common direction; and/or
wherein, in a front view, the deformation zone has an arc-segment shaped outline with rounded transitions between the contact section and the stop section.

6. The housing part according to claim 1,
wherein the deformation zone is formed as a cavity, or
wherein the deformation zone is at least partially filled with a filling material,
wherein the filling material is configured to dampen or delay the deformation of the contact section.

7. The housing part according to claim 1, further comprising a thickness of the contact section that varies along an extension of the contact section in a circumferential direction.

8. The housing part according to claim 1, wherein the contact section and the stop section each have a different stiffness.

9. The housing part according to claim 1,
wherein the housing part is integrally formed in one piece with the functional structure as a single part, and
wherein the functional structure is formed to be half-open or free of undercuts in a direction perpendicular to a circumferential direction and/or
wherein the contact section or the stop section is formed band-shaped or rib-shaped and extends along a circumferential direction.

10. The housing part according to claim 1, further comprising:
at least one element is arranged on the stop section for supporting at least one device of the portable tool in an assembly state selected from the group consisting of: a rib, a strut, a bead, a projection, at least one half-open chamber with a triangular outline, and at least one half-open chamber with a rectangular outline.

11. A tool comprising:
a first housing part,
wherein the first housing part comprises a functional structure for absorbing an impact energy during a collision process,
wherein the functional structure comprises a contact section arranged and configured to directly absorb the impact energy and to undergo deformation,
wherein the functional structure comprises a deformation zone arranged at the contact section and configured to receive the deformation of the contact section,
wherein the functional structure comprises a stop section arranged and configured to limit the deformation of the contact section and to transfer at least a portion of the impact energy, and
wherein the first housing part is arranged and configured to support an energy supply device of the tool in at least one collision direction or to protect the energy supply device during a collision process.

12. The tool according to claim 11, further comprising:
a second housing part,
wherein the first housing part and the second housing part are formed symmetrically with respect to a central plane of the tool or are arranged opposite to each other,
wherein the functional structure of the first housing part and a functional structure of the second housing part each extend, in sections, perpendicularly toward the central plane and/or are spaced apart from the central plane.

13. The tool according to claim 12,
wherein the first housing part and the second housing part each form, at a free end, an opening of a slot for the energy supply device, and
wherein the functional structures of the first housing part and the second housing part are each arranged at the free end to support an inserted energy supply device on a tool-side adjacent to the opening during a collision and to absorb at least a portion of the impact energy or to dissipate the impact energy around the energy supply device.

14. The tool according to claim 11,
wherein the tool is selected from the group consisting of: a chainsaw, a cut-off grinder, a brush cutter, a blower, and a hedge trimmer.

15. A protective element for a portable tool for absorbing an impact energy during a collision process in an assembly state,
wherein the protective element comprises at least one coupling section and at least one locking section for tool-free mounting on at least one housing part of the portable tool,
wherein the at least one coupling section is configured with a first releasable connection to releasably engage a mounting section of the at least one housing part,
wherein the at least one locking section is configured with a second releasable connection to releasably engage a retaining section of the at least one housing part, and
wherein the at least one coupling section is configured to permit a pivoting movement of the protective element about a pivot axis during mounting on the at least one mounting section.

16. The protective element according to claim 15,
wherein the at least one coupling section is configured to be partially plugged or hooked onto the mounting section.

17. The protective element according to claim 15,
wherein the first releasable connection or the second releasable connection comprises a form-fit connection or a force-fit connection.

18. The protective element according to claim 15,
wherein the at least one coupling section and the at least one locking section are arranged at a distance from one another in a longitudinal direction of the protective element, and
wherein the at least one coupling section is arranged, in the longitudinal direction, at an outer end of the protective element.

19. The protective element according to claim 15,
wherein the at least one coupling section comprises a projection that extends transversely to a longitudinal direction of the protective element to form an undercut for a pivotable bearing of the protective element.

20. A kit, the kit comprising:
the tool according to claim 11; and
the protective element according to claim 15.
